(19) United States
(12) Patent Application Publication
(10) Pub. No.: US 2008/0104856 A1
(43) Pub. Date: May 8, 2008

(54) Quick Time Drying Apparatus and Method for Clothes Dryers

(76) Inventor: Malcolm Clare Charles Armstrong, Brockville (CA)

Correspondence Address: MALCOLM ARMSTRONG, 25 VANIER DR., BROCKVILLE, ON, K6V-3J6, CA

(21) Appl. No.: 11/936,789

(22) Filed: Nov. 8, 2007

Related U.S. Application Data
(60) Provisional application No. 60/864,796, filed on Nov. 8, 2006.

(51) Int. Cl. F26B 19/00

(52) U.S. Cl. 34/60

(57) ABSTRACT

The invention relates to an apparatus and methods for reducing energy consumption in both domestic and professional clothes dryers by reducing drying time of clothes being dried. This is result is obtained by using an absorbent, quick drying and/or negatively charged fabric material that is mounted to the drum of the clothes dryer or allowed to circulate with the drying clothes. The drying apparatus is placed inside of a clothes dryer to increase the efficiency of drying clothes in the clothes dryer. The drying apparatus includes a fabric material mounted to a surface, the fabric material being configured to absorb moisture from moist clothes in the dryer and being characterized by being one or both of fast drying and highly absorbent of moisture.

### CROSS-REFERENCE TO RELATED APPLICATIONS

This application claims priority from U.S. Provisional Patent Application No. 60/864,796, filed on Nov. 8, 2006, the entirety of which is incorporated herein.

### TECHNICAL FIELD

The technical field of the invention relates to an apparatus and method for reducing energy consumption in both domestic and professional clothes dryers by reducing drying time of clothes being dried. This result is obtained by using an absorbent, quick drying and/or negatively charged fabric that is mounted to the drum of the clothes dryer.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

As is well known, a typical clothes dryer is a large appliance for drying clothes, bedding, towels, and other linens. Moisture is removed from clothes by a combination of air, heat, and motion. Gas and electric dyers differ mainly in the heat source. Both gas and electric models use a motor to turn a drive belt. The drive belt revolves the drum which holds the clothing. A blower directs air past the heat source and into the drum where it draws lint and moisture from the fabrics through a lint screen and out an exhaust duct. Appliance controls regulate the options, such as temperature and drying time. Some machines use mechanical timers while others rely on digital electronics. Clothes dryers constitute one of the most energy intensive appliances. However, even with the advancement of technology, clothes dryers are one of the few appliances that have not demonstrated significant reduction of energy consumption.

According to the report on “Residential Consumption of Electricity by End Use, 2001” produced by the Energy Information Administration, clothes dryers in the United States used 65.9 billion kWh. Note that this number does not take into account the energy used by commercial clothes dryers (e.g., Laundromats, Hotels, Prisons, Hospitals, etc.). According to one source, as compared to clothes washers, “energy consumption does not vary significantly among comparable models of clothes dryers.” See Worldwise, at the web page: http://www.worldwise.com/clothesdryers.html. Consequently, “ENERGY STAR does not label Clothes Dryers because most Clothes Dryers use similar amounts of energy.” See Energy Star, at the web page: http://www.energystar.gov/index.cfm?c=clotheswash.pr_clothes_washers. Given the need to reduce energy consumption in clothes dryers and the fact that technology has reached a limitation in making cloths dryers more efficient, this invention, Quick Time Drying Apparatus and Method for Clothes Dryers is being proposed and has been developed.

This invention is believed to be useful in meeting the growing demand by both power companies and government agencies to reduce energy use. Further, it should be noted that the effectiveness of Quick Time Drying Apparatus and Method for Clothes Dryers is not limited to electric powered clothes dryers, but is also applicable to clothes dryers operated by either natural gas or propane gas.

Below is a list of several government agencies and nongovernmental organizations (NGOs) that would likely value the benefits of Quick Time Drying Apparatus and Method for Clothes Dryers: This list is not exhaustive.

a. U.S. Department of Energy

b. American Council for an Energy-Efficient Economy

c. Appliance Standards Awareness Project

d. International Energy Agency

e. Energy Efficient Strategies

f. Energy Federation Incorporated

g. Energy Start

h. Energy Efficiency Form

i. Natural Resources Defense Council

j. International Electrotechnical Commission

k. Alliance to Save Energy

l. American Council for an Energy Efficient Economy

m. California Institute for Energy Efficiency

n. Office of Energy Efficiency and Renewable Energy

### BRIEF SUMMARY OF THE INVENTION

In one general aspect, there is provided a drying apparatus for placing inside of a clothes dryer to increase the efficiency of drying clothes in the clothes dryer. The drying apparatus includes a fabric material (that may be perforated) mounted to a surface, the fabric material being configured to absorb moisture from moist clothes in the dryer and being characterized by being one or both of fast drying and highly absorbent of moisture.

Embodiments of the drying apparatus may include one or more of the following features. For example, the surface may be an attachment means for mounting to the inside of the dryer. The attachment means may include at least one magnetic strip, whereby the magnetic strip can be magnetically attached to the drum of the clothes dryer. The attachment means may include at least one Velcro® strip to attach the fabric material to the inside of the dryer. The attachment means may include at least one Velcro® strip affixed to at least one magnetic strip, whereby the magnetic strip is configured to be attached to the inside of the dryer and the Velcro® strip is configured to be attached to the fabric material.

The drying apparatus may be placed inside of the dryer drum on a surface on one or more of the drum, the door or a fin or baffle extending from the drum.

The surface may be a surface of an object that is configured to be placed within the inside of the dryer. The surface may have openings into the object. The object may be hollow and perforated. The object may have one or more of a round shape, an elongated shaped, and a disc shape.

The fabric material may be nylon. The fabric material may be a sheet of nylon. The drying material may be further characterized by being one or more of odor resistant; durable; mildew resistant; heat resistant, and having a negative or positive charge.

Use of the drying apparatus may reduce the amount of time it would take for clothes to dry in the dryer relative to drying clothes in the absence of the drying apparatus. The drying apparatus may be reusable and not limited to a one time use.

In another general aspect there is provided a method for removing moisture from clothes in a clothing dryer. The method includes providing a drying apparatus for placing inside of a clothes dryer to increase the efficiency of drying clothes in the clothes dryer. The drying apparatus includes a fabric material mounted to a surface, the fabric material being configured to absorb moisture from moist clothes in the dryer and being characterized by being one or both of fast drying and highly absorbent of moisture.

Embodiments of the method may include one or more of the following features or those described above. For example, the method may further include placing the drying apparatus in the clothes dryer with moist clothes and operating the dryer.

The surface may include an attachment means for mounting to the inside of the dryer. The attachment means may include at least one Velcro® strip affixed to at least one magnetic strip, whereby the magnetic strip is configured to be attached to the inside of the dryer and the Velcro® strip is configured to be attached to the fabric material. The fabric material may be nylon.

Other embodiments of Quick Time Drying Apparatus and Method for Clothes Dryers may include one or more of the following features. For example, the method may include the use of one or more balls covered with the fabric material to maximize contact between the clothes and the fabric material as a means to reduce drying time even further. The ball may be hollow and perforated to allow the fabric to dry quicker.

The details of various embodiments of the invention are set forth in the accompanying drawings and the description below. Other features and advantages of the invention will be apparent from the description, the drawings, and the claims. For example, the invention may provide one or more of the following advantages: (a) reusable (i.e., depending on further testing of the product, e.g., it could be used up to 2,000 drying cycles); (b) portable (i.e., the product can be easily removed and placed in another clothes dryer, which is especially helpful for Laundromat users); (c) versatile (i.e., can be used in most clothes dryer); (d) inexpensive to make, buy and use; (e) saves wear-and-tear on clothes dryers due to less drying time; (f less wear-and-tear on clothes due to reduced drying time; (g) reduction in greenhouse gas emissions, as less drying time means less energy required; and (h) resilient (i.e., due to the fact that the special material dries extremely fast there is no need to wait in-between dryer loads).

### BRIEF DESCRIPTION OF THE SEVERAL VIEWS OF THE DRAWINGS

FIG. 1 is a perspective view of a drum of a conventional clothes dryer the without the fabric material used.

FIG. 2 is a perspective view of a sheet of fabric material (24×17 inch) with Velcro® strips mounted underneath.

FIG. 3 is a perspective view of magnetic strips with Velcro® attached underneath the magnetic strips.

FIG. 4 is a perspective view of magnetic strips attached to the sheet of fabric material of FIG. 2.

FIG. 5 is a perspective view of the sheet of fabric material magnetically attached to each section of the clothes dryer drum.

FIG. 6 is a perspective view of a prior art clothes dryer.

### DETAILED DESCRIPTION OF THE INVENTION

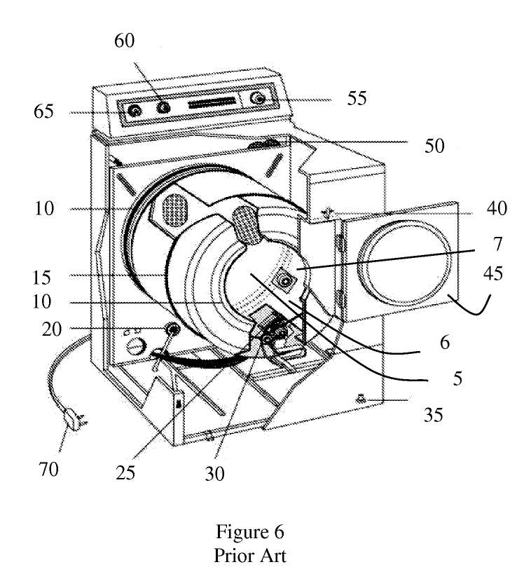

Referring to FIGS. 1 and 6, conventional clothes dryers include a drum rear wall 5, a drum 6, a dryer drum opening 7, one or more drum seals 10, a drum belt 15, a drum roller 20, a motor 25, a pulley 30, an adjustable foot 35, a door interlock switch 40, a door 45, a lint screen 50, a timer 55, a temperature control switch 60, a start switch 65, and an electrical plug 70, a drum 6, a drum rear wall 5, and a dryer drum opening 7 to receive moist clothes into the chamber created by the drum 6, drum rear wall 5 and dryer drum opening 7. The conventional dryer receives the moist clothes and tumbles the clothes in the drum chamber while passing heated air through the drum chamber. The heated air heats the moisture in the clothes and thereby evaporates the moisture from the clothes to dry the clothes.

The inventor believes that the uniqueness of the inventions described herein resides in how the invention functions and what it is able to accomplish while drying clothes. In particular, the inventor is not aware of any product that absorbs moisture from wet clothes inside a clothes dryer to reduce the time required for drying the clothes. The invention does this by using a drying apparatus to physically transfer moisture from wet clothes in the dryer to a fabric material component of the dryer apparatus in the dryer that readily absorbs moisture but also easily gives up moisture.

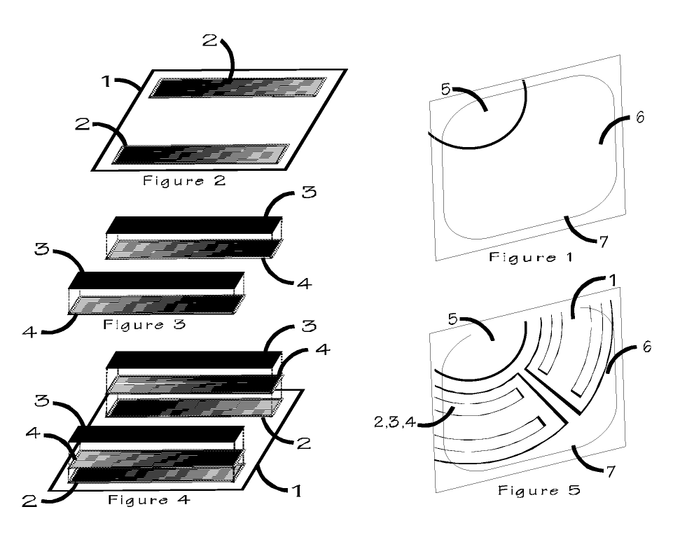

Referring to FIG. 2, in one embodiment of the dryer apparatus, a sheet of fabric material 1 is mounted within the dryer to contact moist clothes, absorb moisture from the clothes, and then allow the moisture to evaporate from the sheet of fabric material 1. In one implementation of the sheet, the size of the sheet of fabric material 1 is 24×17 inches, although the dimensions can be varied as necessary to customize the apparatus to any dryer or for other needs. Underneath the longer side of the sheet of fabric material 1 is placed a 2 inch wide Velcro® strip 2, “loop” part (see FIG. 2). In order to secure the fabric material 1 to the drum of the clothes dryer a 2 inch wide magnetic strip 3 (24 inches) is attached to the fabric material 2 (see FIG. 4). This is done by using a layer of glue 4 to glue the 24 inch long and 2 inch wide Velcro® strip 3 to the magnetic strip (see FIG. 3). Referring to FIG. 5, if the drum of the clothes dryers is divided into three sections one 24×17 sheet can be placed in one section or each section. Optionally or alternatively, the sheet of fabric may also be attached to each fin on the tumbler.

It should be readily understood that the dimensions of the sheet, magnetic strips and Velcro® strips, as well as the structure of the combined sheet of fabric material, magnetic strips, and Velcro® strips, can be varied so long as the concept is followed of placing a fabric material within the dryer drum to absorb moisture from moist clothes upon contact with the moist clothes. Thus, the fabric material can be used in different shapes and configurations to allow them to be strategically placed on and in the dryer drum and other components to more efficiently absorb the moisture or release the moisture.

For example, in a second embodiment of the dryer apparatus, or for use as a separate component of the invention, the fabric material may be applied to a ball such that the ball is partially or completely covered with the same fabric material as in the implementation above. The ball may be solid or hollow with perforated holes. Further, the ball may have openings such that the fabric is affixed or otherwise attached to solid material surrounding opening but also covers the openings. In this manner, the inside of the ball also can be used to accept moisture from the fabric material. One or more dryer balls may be used along with or separately from the sheet of fabric material 1 described above. The balls may be made in a variety of sizes; in one implementation the balls are approximately half the size of a basketball. In others they are the size of a tennis ball, a ping pong ball, a volley ball, etc. Of course, in this embodiment the balls may be shaped in a variety of configurations, such as a rod, an elongated object, a disc, etc. that can tumble within the dryer with the clothes to absorb moisture from the moist clothes. This implementation will further enhance the effectiveness of the sheet of fabric material 1 by increasing contact between the wet clothes and the fabric.

What enables the invention to reduce drying time will now be described. The invention uses a fabric material that absorbs moisture from wet clothes; however, this same material dries extremely fast. In one embodiment, the fabric material is comprised of a hydrophilic nylon, although any hydrophilic, fast drying material may be used. This fabric material relies upon physical contact with the moist clothes to transfer the moisture from the moister clothes to the less moist fabric material. As a potential second mechanism that relies upon the polarity of water, the fabric material optionally may be negatively or positively charged in order to further draw moisture from the wet clothes using this second mechanism. When the clothes dryer is in operation, the drum rotates, and as it rotates the clothes are forced to be in contact with the fabric material. Each time the clothes touch the fabric material, the material absorbs some moisture from the clothes; however, due to the nature of the fabric, the fabric dries extremely fast and thereby allowing it to continually absorb moisture. In particular, during a portion of the rotational cycle of the drum, the fabric material will be in contact with the moist clothes and thus will absorb moisture from the moist clothes. However, in a remainder portion of the rotational cycle of the drum, the moist clothes will be falling away from the drum and therefore the fabric material will be exposed only to the heated air in the dryer. During this portion of the rotational cycle, the fabric material will be able to evaporate off some of the moisture. Further, because the fabric material is expected to have at least a portion in contact with the hot dryer drum, the fabric material will be maintained at an elevated temperature, thereby providing additional energy to evaporate off the moisture before contacting wet clothes again in the next rotational cycle of the drum.

Although the above embodiment uses a hydrophilic nylon for the fabric material, other materials may be used instead or along with the hydrophilic nylon. In general, the fabric material, which may be a material such as a polymer or natural fiber, should have one or more of the following characteristics: (a) hydrophilic (highly absorbent), (b) ability to dry extremely fast, and (c) negatively or positively charged. In addition, the following characteristics may add additional benefits if the fabric material has these properties: (a) odor resistant, (b) durable, (c) mildew resistant, and (d) heat resistant.

The inventor has tested a working prototype of the sheet of fabric material 1. The prototype has proven successful in reducing drying time. A test was completed using a 10 year old residential clothes washer and clothes dryer. As a means to test the viability of the invention four large towels were washed on a normal cycle. The towels were then weighed (15 lbs) and then placed in the clothes dryer without the sheet of fabric material. After 22 minutes the weight of the four towels were recorded. The same four towels were then placed in the washing machine in the same manner as before. When finished they were once again weighed to ensure the weight was the same as the previous test. The prototype was inserted into the clothes dryer, the four towels were then placed in the same dryer and the four towels dried for the same amount of time. After 22 minutes, the towels were weighed again. There was a difference of 1 lbs between the towels when dried with the sheet of fabric material and when dried without the sheet of fabric material. This shows that the sheet of fabric material increases the rate at which moisture is removed from the towels, thereby reducing the drying time.

While several particular forms of the invention have been illustrated and described, it will be apparent that various modifications and combinations of the invention detailed in the text and drawings can be made without departing from the spirit and scope of the invention. For example, references to materials of construction, methods of construction, specific dimensions, shapes, utilities or applications are also not intended to be limiting in any manner and other materials and dimensions could be substituted and remain within the spirit and scope of the invention. Accordingly, it is not intended that the invention be limited, except as by the appended claims.

What is claimed is:

1. A drying apparatus for placing inside of a clothes dryer to increase the efficiency of drying clothes in the clothes dryer, the drying apparatus comprising a fabric material mounted to a surface, the fabric material being configured to absorb moisture from moist clothes in the dryer and being characterized by being one or both of fast drying and highly absorbent of moisture.

2. The drying apparatus of claim 1, wherein the surface comprises an attachment means for mounting to the inside of the dryer.

3. The drying apparatus of claim 2, wherein the attachment means comprises at least one magnetic strip, whereby the magnetic strip can be magnetically attached to the drum of the clothes dryer.

4. The drying apparatus of claim 2, wherein the attachment means comprises at least one Velcro® strip to attach the fabric material to the inside of the dryer.

5. The drying apparatus of claim 2, wherein the attachment means comprises at least one Velcro® strip affixed to at least one magnetic strip, whereby the magnetic strip is configured to be attached to the inside of the dryer and the Velcro® strip is configured to be attached to the fabric material.

6. The drying apparatus of claim 1, wherein the drying apparatus is placed inside of the dryer drum on a surface on one or more of the drum, the door or a fin or baffle extending from the drum.

7. The drying apparatus of claim 1, wherein the surface comprises a surface of an object that is configured to be placed within the inside of the dryer.

8. The drying apparatus of claim 7, wherein the surface has openings into the object.

9. The drying apparatus of claim 7, wherein the object is hollow.

10. The drying apparatus of claim 7, wherein the object has one or more of a round shape, an elongated shaped, and a disc shape.

11. The drying apparatus of claim 1, wherein the fabric material comprises a sheet(s) of nylon or any other material that has the attributes of the claim 1 and 13.

12. The drying apparatus of claim 1, wherein use of the drying apparatus reduces the amount of time it would take for clothes to dry in the dryer relative to drying clothes in the absence of the drying apparatus.

13. The drying apparatus of claim 1, wherein the drying material is further characterized by being one or more of odor resistant; durable; mildew resistant; heat resistant, and having a negative or positive charge.

14. The drying apparatus of claim 1, wherein the drying apparatus is reusable and not limited to a one time use.

15. A method for removing moisture from clothes in a clothing dryer, the method comprising providing a drying apparatus for placing inside of a clothes dryer to increase the efficiency of drying clothes in the clothes dryer, the drying apparatus comprising a fabric material that may be perforated mounted to a surface, the fabric material being configured to absorb moisture from moist clothes in the dryer and being characterized by being one or both of fast drying and highly absorbent of moisture.

16. The method of claim 15, further comprising placing the drying apparatus in the clothes dryer with moist clothes and operating the dryer.

17. The method of claim 15, wherein the surface comprises an attachment means for mounting to the inside of the dryer.

18. The method of claim 15, will include one or more hallow perforated balls of various sizes covered with the drying apparatus of claim 1 and 13 to be inserted into the clothes dryer to further decrease drying time.

19. The method of claim 17, wherein the attachment means comprises at least one Velcro® strip affixed to at least one magnetic strip, whereby the magnetic strip is configured to be attached to the inside of the dryer and the Velcro® strip is configured to be attached to the fabric material.

20. The method of claim 16, wherein the fabric material comprises nylon but not limited to nylon.
